(19) United States
(12) Patent Application Publication
(10) Pub. No.: US 2020/0000207 A1
(43) Pub. Date: Jan. 2, 2020

(54) Backpack integrated with charging function

(71) Applicant: Yubo LIU, Changsha (CN)

(72) Inventor: Yubo LIU, Changsha (CN)

(21) Appl. No.: 16/021,018

(22) Filed: Jun. 28, 2018

(51) Int. Cl. A45F 3/04; H02J 7/00

(52) U.S. Cl. CPC A45F 3/04; A45F 2003/003; H02J 2007/0062; H02J 7/0054

(57) ABSTRACT

A backpack integrated with charging function, having a backpack body, shoulder straps, at least a side pocket and a mobile power bank; a protective cover is provided at an inner side of the backpack body at a position corresponding to the side pocket; a USB wire channel is provided between the protective cover and the side pocket; the USB wire channel is an inner channel formed between two pieces of adhesive, resilient and water-proof fabric bonded together.

### BACKGROUND OF THE INVENTION

The present invention relates to the technical field of backpacks, and more specifically relates to a backpack integrated with charging function.

Electronic products have been infused into our daily lives following technological developments. Electronic products like mobile phones, cameras, tablet computers, portable computers and walkie-talkies are usually carried with us during travel and work. The longer time we stay outdoor, the more important a mobile power source becomes. Most of the backpacks with charging function now available in the market have the following disadvantages:

1. The electrical structure of the charging station of the backpack is fixed and not versatile. According to an existing design, a protective cover is provided at a fixed location on a side surface of the backpack to protect exposure of a USB wire connector installed inside; another end of the wire is connected to a charging power source inside the backpack. However, the USB wire connector is fixed in position and cannot be moved, replaced or dismounted. Therefore, such a design is not versatile to adapt to the user's habits and specialized occasions of use.

The charging station cannot be updated or upgraded. According to an existing design, the specifications of the USB wire and of the USB wire connector are fixed and cannot be upgraded. When an upgraded electronic product is launched in the market, such a design will prevent the users from using such an upgraded rechargeable electronic product which uses for example, fast charge protocol, type C port for charging power source, or wires that are more electrically conductive.

3. Use of the entire backpack is affected after the charging station is damaged. According to an existing design, when the protective cover that protects against exposure of the USB wire connector, disposed on a side surface of the backpack, is damaged, it cannot be replaced and thereby directly affecting the normal use of the entire backpack.

### BRIEF SUMMARY OF THE INVENTION

In view of the aforesaid disadvantages, the present invention provides a backpack integrated with charging function, and is achieved according to the following technical solution.

A backpack integrated with charging function, comprising a backpack body, shoulder straps, at least a side pocket and a mobile power bank; a protective cover is provided at an inner side of the backpack body at a position corresponding to the side pocket; a USB wire channel is provided between the protective cover and the side pocket; the USB wire channel is an inner channel formed between two pieces of adhesive, resilient and water-proof fabric bonded together.

An opening of the USB wire channel has a width not smaller than a width of a connector firmware of a hardware to be charged.

The backpack body and the side pocket form an integral structure.

Two side pockets are configured at two sides of the backpack body respectively, and the USB wire channel is provided between each side pocket and its corresponding side of the backpack.

The backpack body is formed by a first surface material layer, a buffer layer, a second surface material layer, an anti-cutting layer, and an inner lining layer arranged in order from outside to inside of the backpack body.

The side pocket is also formed by the first surface material layer, the buffer layer, the second surface material layer, the anti-cutting layer, and the inner lining layer arranged in order from outside to inside of the side pocket.

A zipper is also provided on the side pocket.

The mobile power bank is positioned within the protective cover or inside the side pocket.

The present invention has the following beneficial effects:

1. Increasing the versatility of the charging station of the backpack used for charging electronic devices. Provided that there is no increase in cost, each of the two sides of the backpack can be configured with a USB wire channel for users to choose according to their habit of use. When the USB wire channel is not in use, the utility of the backpack will not be affected, including its volume, its way of being positioned, as well as its outer appearance.

2. Allowing update or upgrade of rechargeable devices by users. When there are technological developments or hardware updates such as fast charge protocol, type C port for charging power source, or wires that are more electrically conductive, users may update or upgrade the associated devices. The present invention is compatible with such updates or upgrades while not affecting the normal use of the backpack.

3. When the charging station of the present invention has a failure or is damaged, the backpack can still be used normally without affecting the utility of the backpack.

### BRIEF DESCRIPTION OF THE DRAWINGS

FIG. 1 is a structural view of the present invention.

FIG. 2 shows the charging of different electronic devices according to the present invention.

### REFERENCE SIGNS IN THE FIGURES

1—side pocket; 2—mobile power bank; 3—protective cover; 4—USB wire channel.

### DETAILED DESCRIPTION OF THE INVENTION

The present invention will be described further in detail below with reference to the drawings of an embodiment so that the embodiment of the present invention is clearly and comprehensively explained and described. Obviously, the embodiment described herein is only one of the embodiments of the present invention but not inclusive of all possible embodiments of the present invention. All other embodiments based on the teachings of the currently disclosed embodiment conceivable by a person skilled in this field of art without any additional inventive effort should fall within the scope of protection of the present invention.

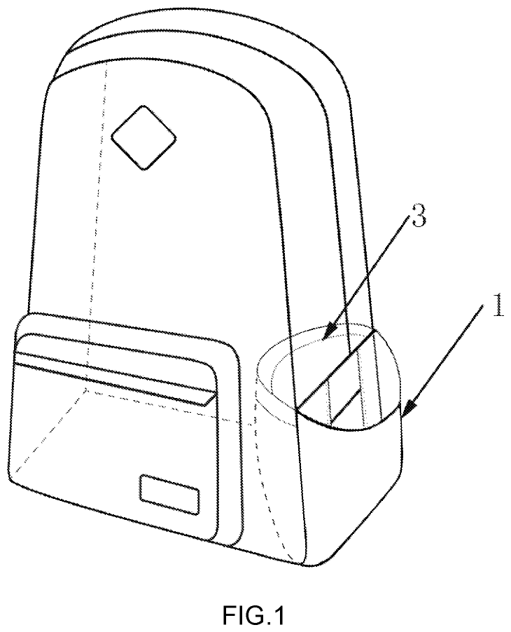

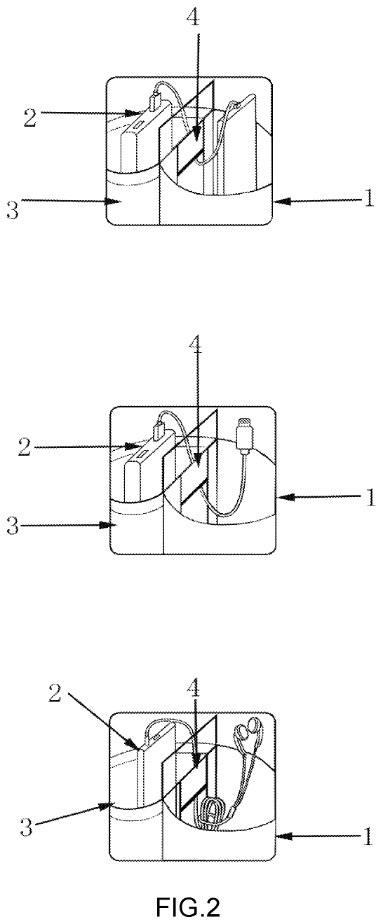

As shown in FIGS. 1 and 2, a backpack integrated with charging function comprises a backpack body, shoulder straps, a side pocket 1 and a mobile power bank 2. A protective cover 3 is provided at an inner side of the backpack body at a position corresponding to the side pocket 1. A USB wire channel 4 is provided between the protective cover 3 and the side pocket 1. The USB wire channel 4 is an inner channel formed between two pieces of adhesive, resilient and water-proof fabric bonded together. A design of fixed USB port of the present invention is configured passing through the USB wire channel 4 disposed between the inner side and an outer side of the backpack into the side pocket 1 of the backpack. Accordingly, the outer appearance of the backpack is remained unchanged. The two pieces of fabric defining the USB wire channel 4 are also flat, and thus being negligible with respect to their effect on additional thickness of the backpack in general. The two pieces of fabric defining the USB wire channel 4 are also small in size and are tightly adhered with each other achieving good sealing effect. Also, the two pieces of fabric have folds which fold back to prevent objects inside the backpack from falling out through the USB wire channel 4.

According to a specific embodiment, an opening of the USB wire channel 4 has a width not smaller than a width of a connector firmware of a hardware to be charged, so as to adapt to any widths of any connector firmware of any hardware to be charged.

According to a specific embodiment, the backpack body and the side pocket form an integral structure. Two side pockets may be configured at two sides of the backpack body respectively, and the USB wire channel is provided between each side pocket and its corresponding side of the backpack. The present invention does not have fixed electrical firmware like connector or wire cable. The integral structure can simplify the manufacturing process, lessen connections between different components and increase the entire structural strength.

According to a specific embodiment, the backpack body is formed by a first surface material layer, a buffer layer, a second surface material layer, an anti-cutting layer, and an inner lining layer arranged in order from outside to inside of the backpack body. The side pocket is also formed by the first surface material layer, the buffer layer, the second surface material layer, the anti-cutting layer, and the inner lining layer arranged in order from outside to inside of the side pocket. A zipper is also provided on the side pocket. The buffer layer is for protection against external impact which may cause objects inside to be damaged. The anti-cutting layer is for increased security purpose by preventing objects inside the backpack from falling out through protection of the backpack body against cutting by sharp objects.

According to a specific embodiment, the mobile power bank is positioned within the protective cover or inside the side pocket. The protective cover is fixed to an inner side of the backpack and cannot be moved or dismounted. One end of an extended USB wire is fixed within the protective cover and cannot be moved or dismounted; another end of the extended USB wire is left inside the backpack to be connected to the mobile power bank.

An embodiment of the present invention is shown and described above. However, various changes, modifications, replacements and variations of the embodiment disclosed herein can be made by a person skilled in this field of art without deviating from the principle and essence of the present invention. The scope of the present invention is defined by the claims and their equivalence.

What is claimed is:

1. A backpack integrated with charging function, comprising a backpack body, shoulder straps, at least a side pocket and a mobile power bank; wherein a protective cover is provided at an inner side of the backpack body at a position corresponding to the side pocket; a USB wire channel is provided between the protective cover and the side pocket; the USB wire channel is an inner channel formed between two pieces of adhesive, resilient and water-proof fabric bonded together.

2. The backpack integrated with charging function of claim 1, wherein an opening of the USB wire channel has a width not smaller than a width of a connector firmware of a hardware to be charged.

3. The backpack integrated with charging function of claim 1, wherein the backpack body and the side pocket form an integral structure.

4. The backpack integrated with charging function of claim 3, wherein two side pockets are configured at two sides of the backpack body respectively, and the USB wire channel is provided between each side pocket and its corresponding side of the backpack.

5. The backpack integrated with charging function of claim 1, wherein the backpack body is formed by a first surface material layer, a buffer layer, a second surface material layer, an anti-cutting layer, and an inner lining layer arranged in order from outside to inside of the backpack body.

6. The backpack integrated with charging function of claim 1, wherein the side pocket is formed by a first surface material layer, a buffer layer, a second surface material layer, an anti-cutting layer, and an inner lining layer arranged in order from outside to inside of the side pocket.

7. The backpack integrated with charging function of claim 1, wherein a zipper is provided on the side pocket.

8. The backpack integrated with charging function of claim 1, wherein the mobile power bank is positioned within the protective cover or inside the side pocket.
